(19) United States
(12) Patent Application Publication
(10) Pub. No.: US 2025/0315430 A1
(43) Pub. Date: Oct. 9, 2025

(54) CONVERSATION AGENT FOR DATA INTERPRETATION AND DIAGNOSIS

(71) Applicant: Bytedance Technology Ltd., Grand Cayman (KY)

(72) Inventors: Ding XU, Beijing (CN); Hai LIANG, Beijing (CN); Xinwei YANG, Beijing (CN); Wanshi QU, Beijing (CN); Hailei ZHANG, Beijing (CN); Pan HE, Beijing (CN); Feng HAN, Singapore (SG)

(21) Appl. No.: 19/244,584

(22) Filed: Jun. 20, 2025

(51) Int. Cl. G06F 16/2452; G06F 16/248; G06F 40/35

(52) U.S. Cl. CPC G06F 16/24522; G06F 16/248; G06F 40/35

(57) ABSTRACT

A conversation agent is described. An example method includes receiving a user request from a user interface of a conversation agent; determining a predicted intent of the user request; selecting a prompt template from a plurality of prompt templates corresponding to respective intents based on the predicted intent of the user request; generating a prompt using the prompt template and the user request; processing the prompt using a generative language model to generate an output; and displaying, on the user interface, a response to the user request generated based on the output.

### TECHNICAL FIELD

The present disclosure generally relates to data interpretation and diagnosis, for example, by a conversation agent based on artificial intelligence (AI) or machine learning techniques.

### BACKGROUND

A conversation system is a system that can provide a response given a user input. Conversation systems are used in many fields, such as customer support. Some conversation systems are mainly based on rule templates, and developers of these systems need to manually write a large number of dialogue rules and/or templates to handle various possible user inputs. Thus, these conversation systems can only handle a limited number of predetermined specific scenarios and problems, lack flexibility and adaptability to new or unexpected user requests, and have high development costs and long development cycles, making these conversation systems difficult to meet complex and changing real-world application needs.

### SUMMARY

This specification describes a conversation agent for data interpretation and diagnosis, for example, by a conversation agent based on artificial intelligence (AI) or machine learning techniques. The conversation agent can interact with users through natural language processing technology (e.g., using a generative language model), can understand the user's intentions, and can provide accurate and appropriate responses. In some implementations, the conversation agent can assist users (such as customers and operations staff) in data query and retrieval, interpreting data, interpreting diagnostic results, and suggesting content through interactive dialogue. Thus, the conversation agent can help the users improve their efficiency, provide the users with objective and accurate data analysis results and feasible suggestions. In some implementations, the described techniques can use large language models (LLMs) to diagnose and analyze the business status of merchants in an ecommerce platform based on historical data performance. In some implementations, the described techniques can provide strategic suggestions and improvement opportunities for merchants based on the results of the analysis, helping the merchants improve operational efficiency and achieve rapid development.

In one aspect, the present disclosure describes a method. The method includes the following operations: receiving a user request from a user interface of a conversation agent; determining a predicted intent of the user request; selecting a prompt template from a plurality of prompt templates corresponding to respective intents based on the predicted intent of the user request; generating a prompt using the prompt template and the user request; processing the prompt using a generative language model to generate an output; and displaying, on the user interface, a response to the user request generated based on the output.

In another aspect, the present disclosure describes an apparatus including one or more processors and one or more computer-readable memories coupled to the one or more processors. The one or more computer-readable memories store instructions that are executable by the one or more processors to perform the above-described method or operations.

In still another aspect, the present disclosure describes a non-transitory computer-readable storage medium. The non-transitory computer-readable storage medium stores programing instructions executable by one or more processors to perform the above-described method or operations.

In some implementations, these general and specific aspects may be implemented using a system, a method, or a computer program, or any combination of systems, methods, and computer programs. The foregoing and other described aspects can each, optionally, include one or more of the following aspects:

In some implementations, the predicted intent comprises data query, and the output is in a domain-specific language used to manage data, and the method or operations comprise performing the data query using the output in the domain-specific language.

In some implementations, the domain-specific language is Structured Query Language (SQL), and the prompt comprises text data in natural language, and the method or operations comprise: processing the prompt comprising the text data in the natural language using the generative language model to generate the output comprising a SQL query, wherein the generative language model is trained to generate SQL queries from natural language text data; retrieving data from a database using the SQL query; and displaying, on the user interface, the retrieved data.

In some implementations, the predicted intent comprises data interpretation, and the method or operations comprise: processing the prompt using the generative language model to generate a data interpretation result; and displaying, on the user interface, the data interpretation result.

In some implementations, the predicted intent comprises seeking a recommendation, and the method or operations comprise: processing the prompt using the generative language model to generate recommendation data; and displaying, on the user interface, the recommendation data.

In some implementations, the method or operations comprise: processing the prompt using the generative language model to generate a sequence of characters representing two or more data formats; and streaming, on the user interface, the sequence of the characters representing the two or more data formats, wherein the streaming comprises: displaying, sequentially on the user interface, a current portion of the sequence of the characters that has been generated by the generative language model while the generative language model generates a next portion of the sequence of the characters that is after the current portion of the characters.

In some implementations, the two or more data formats comprise: a text data format and a table data format.

In some implementations, the streaming the sequence of the characters comprises: displaying, sequentially on the user interface, a first portion of the sequence of the characters representing a structure of a table and a heading of the table that has been generated by the generative language model while the generative language model generates a second portion of the sequence of the characters representing text data for the table; and filling the table, sequentially on the user interface, using the second portion of the sequence of the characters representing the text data for the table.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is an illustration of an example architecture of a conversation agent.

FIG. 1B is an example flow diagram that illustrates an example workflow for managing interactions between a conversation agent and a user.

FIG. 1C is an illustration of an example system for a conversation agent.

FIG. 2 is a flow diagram that illustrates an example system for a conversation agent.

FIGS. 3A-3D are illustrations of an example result for streaming mixed data formats.

FIG. 4 is an illustration of an example process for a conversation agent.

FIG. 5 is a flow diagram that illustrates an example process for a conversation agent.

FIG. 6 is a block diagram of an example computer system.

Like reference numbers and designations in the various drawings indicate like elements.

### DETAILED DESCRIPTION

In general, this specification describes example techniques for conversation agents for data interpretation and diagnosis, for example, by a conversation agent (also referred to as dialogue agent or robot, or intelligent conversation agents) based on artificial intelligence (AI) or machine learning techniques. With the rapid development of AI technology, intelligent conversation agents have become a hot research and application field. For example, in a large language model (LLM) context, an agent can perform analysis and interpretation, can make plans and make decisions, and can execute complex tasks.

The techniques described in this specification can allow a conversation agent to be designed to interact with users through natural language processing (NLP) technology. The intelligent conversation agents can be implemented to understand users' intentions and provide accurate and appropriate responses. The intelligent conversation agents can be used in numerous applications such as customer service and smart assistants.

In one example ecommerce application, the described techniques can be used by an ecommerce platform to support merchants on the ecommerce platform. For example, the described techniques can use the powerful ability of large models to diagnose and analyze the business status of merchants based on historical data performance. Moreover, it will provide strategic suggestions and growth tasks for merchants based on the results of the analysis, helping them improve operational efficiency and achieve rapid development and improvement. In some implementations, the described techniques can assist merchants in interpreting data, interpreting diagnostic results, and suggesting content through interactive dialog. The described techniques can interact with customers and operators of an ecommerce platform, and can provide them with objective and scientific store data analysis and feasible suggestions.

Particular embodiments of the subject matter described in this specification can be implemented so as to help address some or all of the issues and help realize one or more of the following advantages.

In some implementations, the described techniques can improve conversation efficiency. Unlike traditional policy-based and/or rule-based conversation systems that consumes a lot of computation resources for querying a large amount of data and performing data aggregation and analysis, the described techniques can predict user intent and can generate an accurate and effective response using the predicted user intent, reducing the system computation time, reducing the response time, and improving user experience.

In some implementations, the described techniques can reduce the response time to users through a dialog streaming scheme. The dialog streaming scheme can stream a sequence of characters generated by a generated language model by sequentially displaying a portion of the sequence while a subsequent portion is being generated by the generative language model. For example, the dialog streaming scheme can stream a sequence of characters to have a typewriter effect that mimics a typewriter outputting the sequence of characters sequentially. In some implementations, the dialog streaming scheme can stream data in mixed formats, such as a text data format and a table data format. In some implementations, the system can first display a structure and heading of a table, and afterwards, can fill in the data with a character stream, for example, to mimic the effect of a typewriter filling in data into a provided table. By streaming data in mixed format, the described techniques can reduce the response time to a user query and can improve user experience.

In some implementations, the described techniques can improve the effectiveness and accuracy of a conversation. Rather than merely using manually designed strategies and rules, in some implementations, the described techniques can improve the accuracy and effectiveness of the conversation output in specific domains using generative language models trained on data in a specific domain to capture the characteristics of the specific domain. In some implementations, the described techniques can predict user intent, can select a prompt template based on the predicted user intent, and can generate an effective prompt using the prompt template. Thus, the described techniques can more quickly and accurately adapt to the dialogue needs of different use cases or different scenarios, while improving the accuracy and professionalism of the answers.

In some implementations, an AI agent can be implemented as a combination of a LLM, a memory, a planning skill sets, and a tool kit. For example, a conversation agent can, using natural language interaction and based on a merchant's query, understand the semantics, retrieve corresponding standard operating procedures (SOPs), and gradually display the process, data, and the conclusions. By utilizing the advantages of large models, the merchant's intention can be more accurately understood, and the language of the conclusion can be organized and presented in a natural and fluent way.

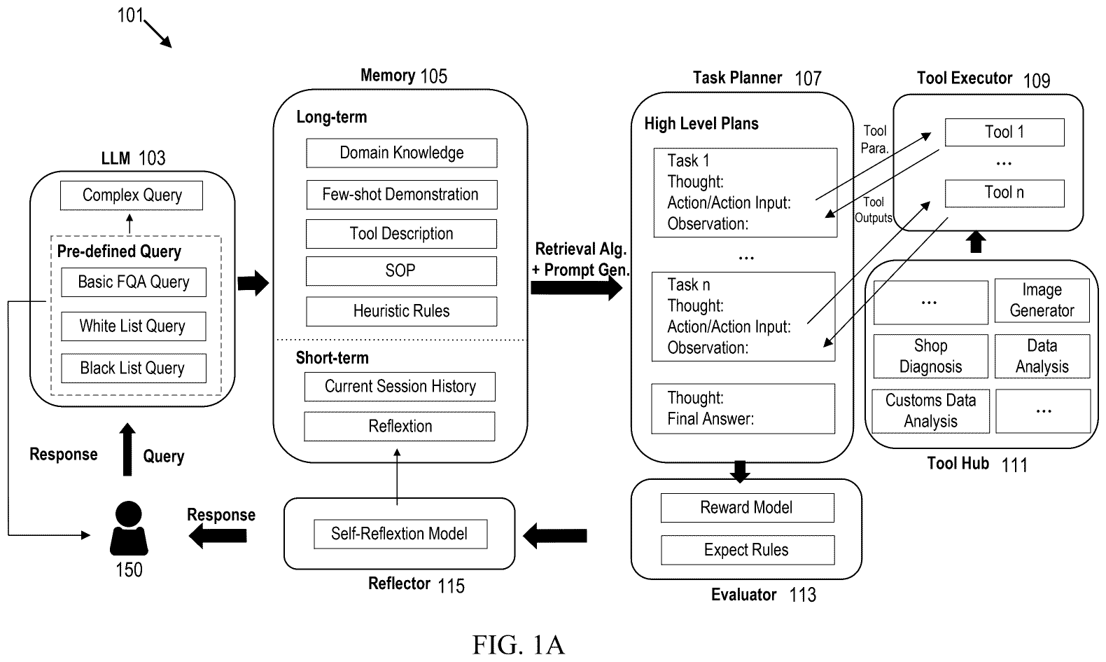

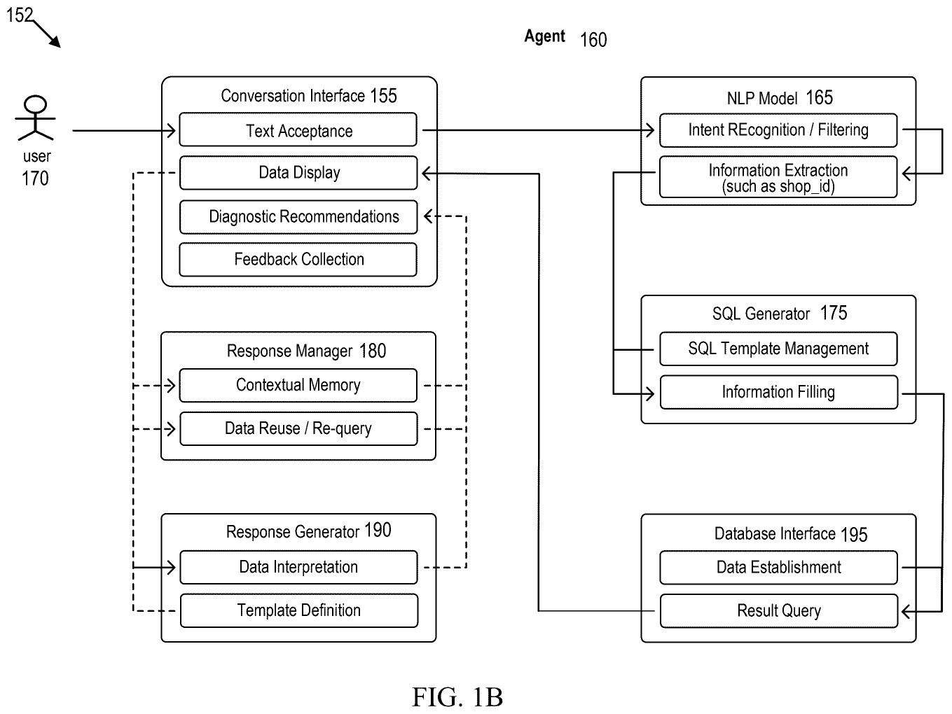

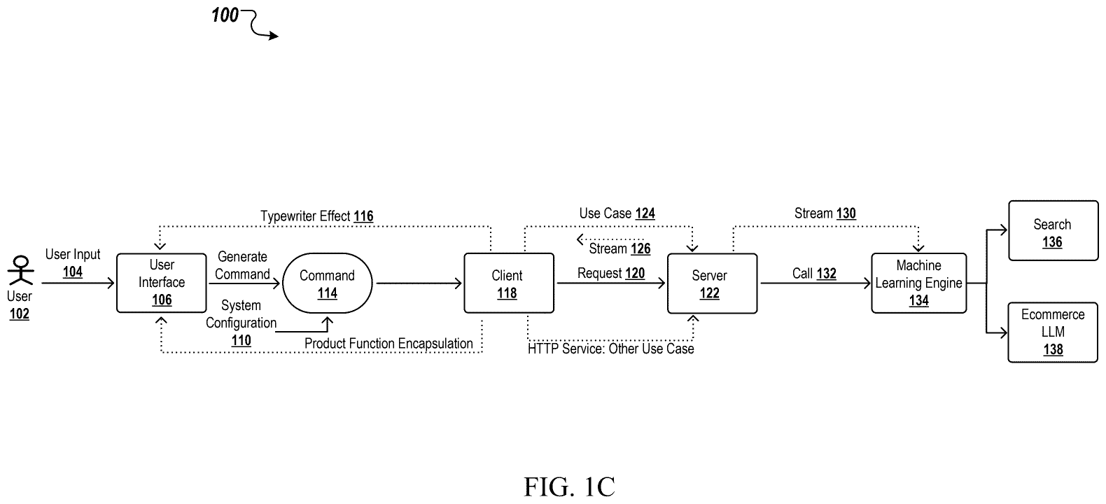

FIG. 1A is an illustration of an example architecture 101 of a conversation agent. The architecture 101 includes multiple sub-systems or components for interacting with a user 150. The multiple sub-systems or components include, for example, one or more of an LLM 103, a memory 105, a task planner 107, a tool executor 109, a tool hub (or tool set) 111, an evaluator 113, and a reflector 115. The conversation agent can include additional or different sub-systems or components, or some of the sub-systems or components can be implemented as one or more external components or in a distributed manner.

In some implementations, the LLM 103 can be used to implement intent understanding. The system can conduct in-depth analysis and understanding of the intention of the user query describing the problem, the requirement, or the task being faced. The system can process and analyze relevant information in detail, can capture key points and core objectives, and can clarify the background, scope and expected results of the task. In some implementations, the system can eliminate possible ambiguities, ensure an accurate grasp of the intention of the user, and can establish a solid foundation for subsequent processing. In some implementations, the LLM 103 can use natural language processing (NLP) techniques. In some implementations, the system can perform intent recognition and filtering. The system can accurately identify the user's intention in the query (e.g., the user input text), and can exclude irrelevant or noisy information and extra key objectives through effective filtering mechanisms. In some implementations, the system can perform information extraction. The system can accurately extract key information and elements from the query (e.g., the user input text), providing a foundation for subsequent processing and analysis.

In some implementations, the LLM 103 can include multiple models or sub-agents specialized in different user intents. A user intent can indicate a use case or a scenario for the conversation. Examples of user intents of a user request include: data query, data interpretation, and diagnosis and/or recommendation. In some implementations, an individual model, agent, or module can be trained for a respective user intent.

In some implementations, the LLM 103 can include a model (agent, or module) trained for intelligent query. This model can have powerful intelligent search capabilities and can accurately understand the user's needs in the input query. Through advanced NLP technologies and algorithms, the model can analyze the user's input text in depth, and can quickly and accurately extract key information and intentions. When processing query requests, the system can comprehensively consider various factors, such as keywords, context, user historical behavior, etc., to provide the most relevant and accurate query results. In some implementations, the model can support multi-dimensional query methods to meet the needs of users in different scenarios.

In some implementations, the LLM 103 can include a model (agent, or module) trained for intelligent diagnosis. The model can use complex data analysis and machine learning algorithms to comprehensively and diagnose the input information in depth. The model can quickly identify potential problems, patterns, and trends, and can provide users with accurate and valuable diagnostic results. Whether it is a complex business process or a massive data collection, the intelligent diagnosis model can quickly identify key points and abnormal situations, and provide targeted suggestions and solutions.

In some implementations, the LLM 103 can include a model (agent, or module) trained for data interpretation. The model can transform complex data into easy-to-understand and valuable information. The model can use intuitive charts, clear text descriptions, and easy-to-understand analysis to help users quickly grasp the connotation and significance of data. Whether it is trend analysis, correlation research, or interpretation of outliers, the model can present the data interpretation results to users in a clear and understandable way, providing strong support for decision-making.

During the operation of these models (agents, or modules), the system can identify the intent of user input by constructing agents of different capabilities. When calling different agents to produce a corresponding content, in some implementations, the system can perform risk control interception to ensure compliance and security of the operations. In some implementations, the system can perform permission verification to ensure the legitimate access and use of users. In some implementations, the system can collect user feedback to continuously optimize and improve the service. In some implementations, the system can perform session management to maintain the coherence and effectiveness of the dialogue. In some implementations, the system can use a streaming dialogue module to achieve a real-time and smooth interactive experience.

In some implementations, the memory 105 can include a long-term memory and a short-term memory. In some implementations, the system can perform knowledge retrieval and can obtain historical data records. In some implementations, the system can utilize various resources and channels for knowledge retrieval. The system can access various literature, databases, knowledge bases, etc., to obtain information and knowledge related to the task in the user query. In some implementations, the system can retrieve and obtain historical data records, such as the processing methods of similar tasks, experience and lessons learned, etc., as a reference for the current task.

In some implementations, the task planner 107 can perform task breakdown and planning. In some implementations, the system can break down the overall task into several specific sub-tasks and can develop a detailed operating plan for each subtask. In some implementations, the system can clarify the order, dependency, and time stamps between the sub-tasks, can allocate resources and manpower reasonably, and can develop a clear and feasible task execution roadmap.

In some implementations, the tool executor 109 can access tools. In some implementations, the system can choose appropriate execution tools and techniques based on the nature and requirements of the task. The execution tools and techniques can include software applications, analytical models, experimental equipment, etc. The system can choose appropriate execution tools and techniques to ensure that the task can be executed efficiently and accurately.

In some implementations, the evaluator 113 can execute result evaluation. In some implementations, the system can conduct a comprehensive and objective evaluation of the results of task execution. In some implementations, the system can compare the expected goals with the actual achieved results, analyze the gaps and shortcomings. In some implementations, the system can evaluate the results in terms of accuracy, completeness, and effectiveness, etc.

In some implementations, the reflector 115 can perform reflection. In some implementations, the system can reflect on the entire process of task execution in depth, and can summarize successful experiences and lessons learned from failures. In some implementations, the system can consider whether the methods and strategies adopted in each stage are reasonable and effective, which aspects can be improved and optimized, and can provide a reference for similar tasks in the future.

In some implementations, the system can output a response to the user query. In some implementations, the system can, based on the techniques of the above stages, output a complete, clear, and persuasive conclusion. The conclusion can cover the achievement of the goals of the task, main findings, suggestions, and improvement directions, etc., which can provide strong support and basis for decision-making.

FIG. 1B is an example flow diagram that illustrates an example workflow 152 for managing interactions (e.g., a conversation or dialogue) between a conversation agent 160 and a user 170 (e.g., the user 150). The conversation agent 160 can be implemented according to the example architecture 101 or in another manner.

In some implementations, for interacting with the user 170, the conversation agent can include a conversation interface 155 that manages interactions with the user 170. For example, conversation interface 155 can be implemented to perform one or more of the following functions: (a) Text Acceptance: Able to accurately receive various forms of text information input by users, whether the text is concise and clear questions or detailed and complex descriptions, the text can be obtained completely and accurately; (b) Data Display: Present relevant data and information to users in a clear, intuitive, and easy-to-understand manner, through various forms such as charts and lists, users can quickly grasp key points; (c) Diagnostic recommendations: Based on the analysis and processing of user input, provide targeted diagnostic results and practical suggestions to help users solve problems or optimize decisions; and (d) Feedback collection: Actively collect user feedback on the interaction process and results, including satisfaction evaluation, improvement suggestions, etc., in order to continuously optimize service quality.

In some implementations, the conversation agent 160 can include a NLP model 165 that perform one or more of the following functions: (a) Intent recognition filtering: accurately identify the user's intention in inputting text, and through effective filtering mechanisms, exclude irrelevant or noisy information, and extract key demands; and (b) Information Extraction: Accurately extract key information and elements from user-input text, providing a foundation for subsequent processing and analysis.

In some implementations, the NLP model 165 can be implemented by the LLM 103 as described with respect to FIG. 1A. In some implementations, the conversation agent 160 can include an SQL generator 175 that perform one or more of the following functions: (a) SQL Template Management: Effectively manage various types of SQL templates, including creating, updating, deleting, and other operations, to ensure the accuracy and applicability of the templates; and (b) Information filling: Accurately fill the extracted relevant information into the SQL template to generate complete and effective SQL queries.

In some implementations, the conversation agent 160 can include a response manager 180 that perform one or more of the following functions: (a) Contextual Memory: Able to remember the contextual information of previous conversations, making the conversation coherent and logical and better understanding the user's needs; (b) Data reuse: make full use of existing data and information, avoid duplicate acquisition and processing, and improve dialogue efficiency; and (c) Data Query/Re-query: Based on the user's needs and the progress of the conversation, timely and accurate data query operations are performed to obtain the required information.

In some implementations, the conversation agent 160 can include a response generator 190 that perform one or more of the following functions: (a) Data Interpretation: Conduct in-depth analysis and interpretation of the obtained data, transforming complex data into easy-to-understand language and content; and (b) Template Definition: Define various answer templates to ensure standardized format, clear language, and rigorous logic of the answers.

In some implementations, the conversation agent 160 can include a database interface 195 that perform one or more of the following functions: (a) Data establishment: responsible for building and maintaining the database, including data entry, update, optimization, etc., to ensure the quality and integrity of the data; and (b) Result Query: Able to efficiently and accurately query the required result data from the database, providing strong support for answer generation.

In some cases, users may want to ask further questions about the results when they are not satisfied with the results provided by the conversation agent 160. In some implementations, the conversation agent 160 can generate a supplement response to the response to the user query, e.g., supporting users to have multiple rounds of dialogue, allowing users to ask further questions about previous questions, when the results of the initial answer do not meet the user's expectations.

FIG. 1C is an illustration of an example system 100 for a conversation agent. The system 100 can be referred to as a conversation agent system. The system 100 includes a user interface 106, a client 118, a server 122, and a machine learning engine 134.

In some implementations, the system 100 can receive a user request from a user interface 106 of the conversation agent. The user interface 106 can be implemented on a client 118, e.g., a mobile device or a laptop. In some implementations, the user request can include a user input 104 provided by a user 102 through the user interface 106. For example, the user input 104 can be “shop A's GMV this week vs. last week.” Here, GMV is Gross Merchandise Value, which represents the total sales value of goods sold on a platform or marketplace during a specific period.

The system 100 (e.g., the client 118) can generate a command 114 using the user input 104, and based on system configuration 110. The client 118 can generate a request 120 for a service based on the command 114.

Each user request can correspond to a user intent. In the example user input “shop A's GMV this week vs. last week,” the user intent is data query, e.g., querying sales data for shop A for this week and last week. The system 100 can determine a predicted intent of the user request. For example, the client 118, the server 122, or both, can determine a user case 124, which is the predicted intent of the user input 104.

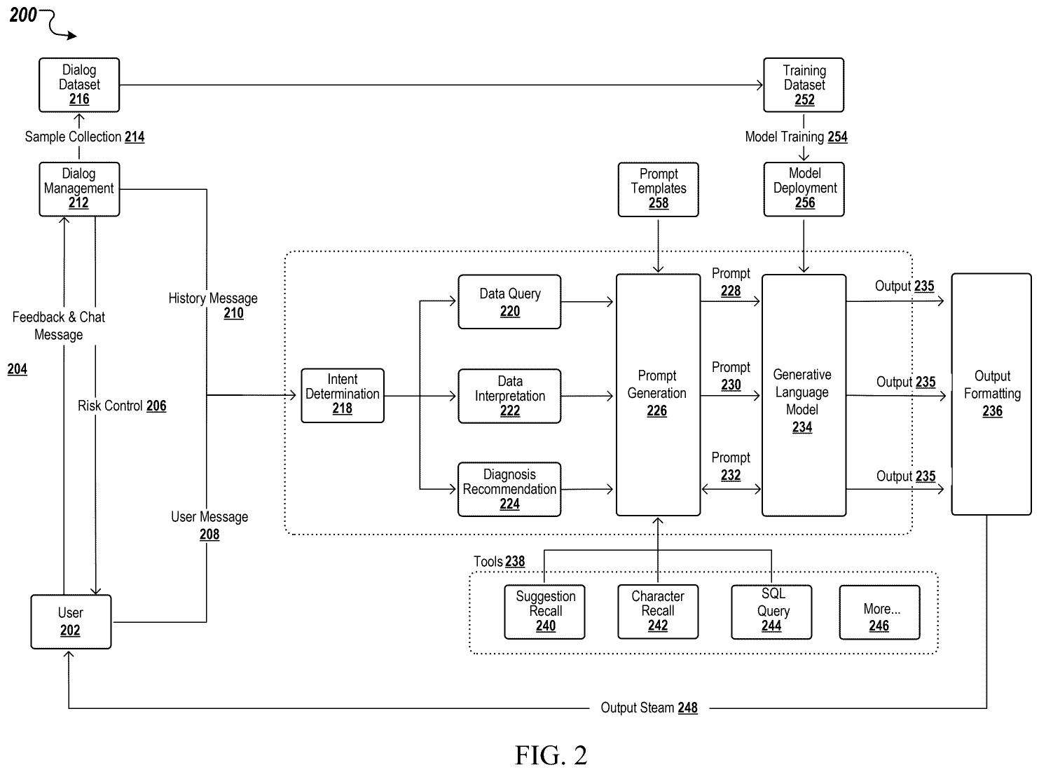

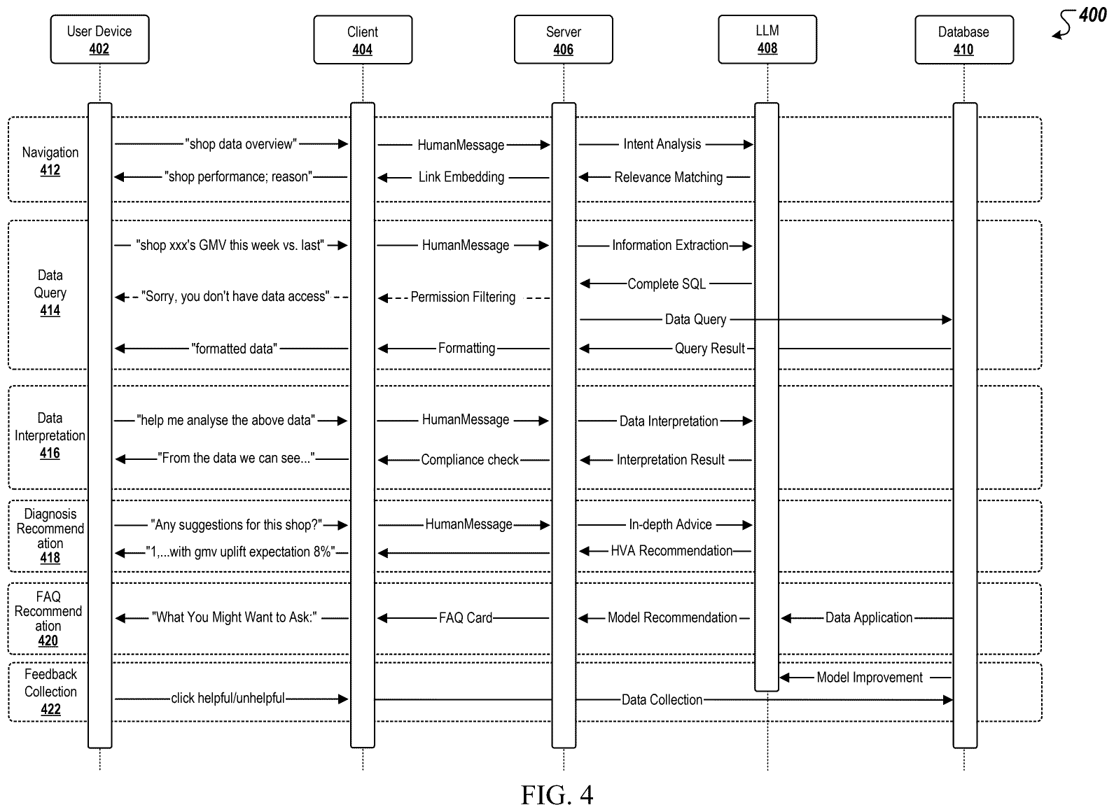

The system 100 processes the request 120. In some implementations, the system 100 can perform prompt engineering. For example, a server 122 can process the request 120 and can generate a prompt to a generative model using the request 120. In some implementations, the system 100 can select a prompt template from a plurality of prompt templates corresponding to respective intents based on the predicted intent. The system 100 can generate the prompt using the prompt template and the user request. More details of prompt engineering are described herein in connection with FIG. 2 and FIG. 4.

For example, the system 100 can determine that the user case 124 is likely a “data query” user case based on the user input 104 or command 114 “shop A's GMV this week vs. last week.” The system can select a prompt template for the “data query” use case. The system 100 can generate a prompt using the prompt template for the “data query” use case. In some implementations, the client 118 can provide an HTTP service to the server 122 for other use cases. In some implementations, the client 118 can provide product function encapsulation for the user interface 106.

The server 122 can provide a call 132 to a machine learning engine 134. In some implementations, the call 132 can include the prompt generated using the request 120. The machine learning engine 134 can generate an output by performing one or more operations, such as performing search 136, or calling a machine learning model. For example, the machine learning engine 134 can deploy a trained generative language model that can provide an output to the request 120 included in the call 132. In some implementations, the generative language model can be a large language model (LLM) (e.g., an LLM 103 or an ecommerce LLM 138) trained to provide a conversational output in natural language.

In some implementations, the system can use a generative language model (e.g., an ecommerce LLM 138) that reduces the computation cost (e.g., memory, processors) of the system. Compared to most of the commercialized generative language models, the system can use a generative language model that has a neural network architecture with fewer parameters, but still achieving good performance in the outputs from the model. By using a neural network architecture with fewer parameters, the system can reduce the computation cost while maintaining good performance.

The system 100 generates an output. In some implementations, the machine learning engine 134 can generate an output that includes a sequence of characters, e.g., the stream 130. The machine learning engine 134 can provide the output, e.g., the stream 130, to the server 122. The server 122 can provide output, e.g., the stream 126, to the client 118.

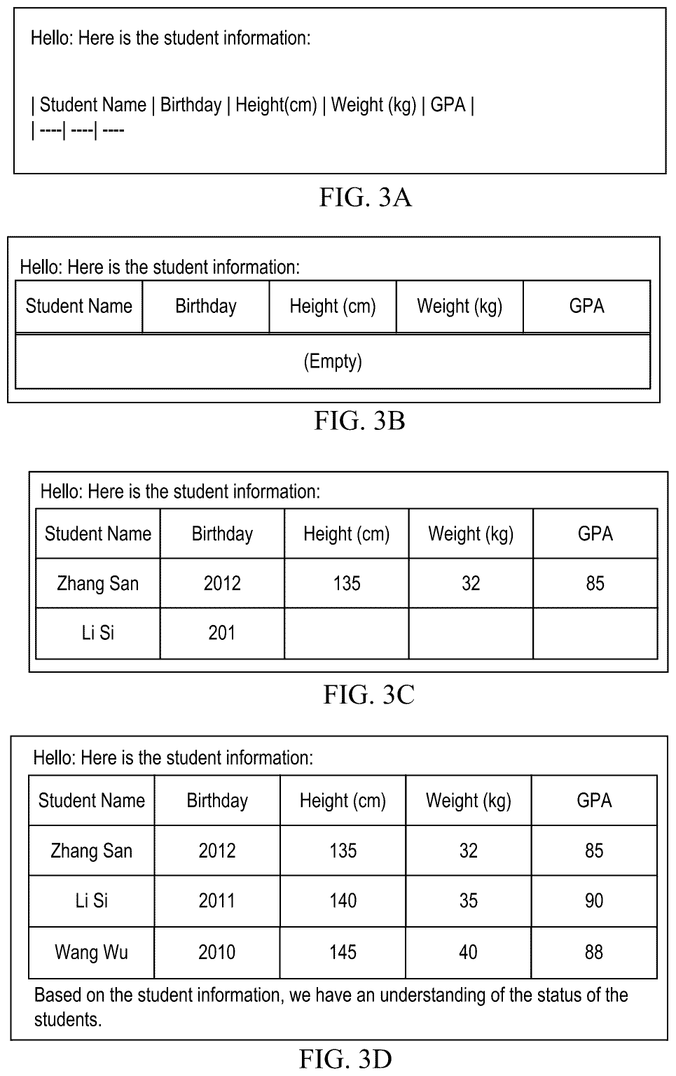

The system 100 displays, on the user interface, a response to the user request generated based on the output. In some implementations, the system 100 can process the prompt using the generative language model to generate a sequence of characters. The system 100 can stream, on the user interface 106, the sequence of the characters. The system 100 can display, sequentially on the user interface, a current portion of the sequence of the characters that has been generated by the generative language model while the generative language model generates a next portion of the sequence of the characters that is after the current portion of the characters. For example, the client 118 can display a typewriter effect 116 of the stream 126 on the user interface 106. More details of streaming the output are described herein in connection with FIG. 2 and FIGS. 3A-3D.

FIG. 2 is a flow diagram that illustrates an example system 200 for a conversation agent. The system 200 can implement a conversation agent. The system 200 includes an intent determination engine 218, a prompt generation engine 226, a generative language model 234, and an output formatting engine 236.

The system 200 receives a user request from a user interface of the conversation agent. For example, the system 200 can receive a user message 208 from a user 202.

The system 200 (e.g., the intent determination engine 218) determines a predicted intent of the user request. For example, the intent determination engine 218 can process the user message 208 using a machine learning model or a rule-based system to identify the predicted intent of the user message 208. For example, the system 200 (e.g., the intent determination engine 218) can perform intent determination using an LLM agent. The predicted user intent can be data query 220, data interpretation 222, diagnosis recommendation 224, chatting, or a combination of these. In some implementations, other types of predicted user intent are possible. More examples are described herein in connection with FIG. 4.

In some implementations, the system 200 can obtain history user request data (e.g., history message 210), and the system 200 can determine a predicted intent of the user request based on both the (current) user request and history user request data. For example, the intent determination engine 218 can determine a predicted intent of the user message 208 based on the user message 208 and the history message 210.

The system 200 can maintain the plurality of prompt templates 258. Each prompt template can correspond to a user intent, for example, by customizing the template to cater to the user intent (e.g., a user case or a scenario of the conversation). The prompt template can include a system prompt that specifies goals, limitations, instructions of using a generative language model for the user case or the scenario.

In some implementations, the prompt template 258 can be in a predetermined and structured format. In some implementations, the prompt template 258 can guide the generative language model 234 to generate a desired type of output 235. In some implementations, the prompt template 258 can include a predefined structure. In some implementations, the prompt template 258 can include one or more parameters at one or more locations in the prompt template. The one or more parameters can have variable values. Through the predefined structures and the one or more parameters, in some implementations, the prompt template 258 can help the generative language model 234 to have an improved accuracy in understanding requirements of a task and to generate a consistent output with improved quality.

In some implementations, the prompt template 258 can improve computation efficiency in processing context information. In some implementations, the prompt template 258 can be carefully designed such that the system can clearly communicate an instruction to the generative language model 234 using fewer tokens. In some implementations, the system can save the display space in the user interface that is used to display the context information. In some implementations, the system can process more content related to the current user intent. In some implementations, the system can reduce computation cost and computation resources, such as processing power, storage, memory, and network bandwidth.

In some implementations, the prompt template 258 can improve user experience. In some implementations, the prompt template 258 can include role definition, tone configuration, and requirements for output format. Thus, in some implementations, the prompt template 258 can ensure that the system can provide an output that meets the user's expectations and provides a professional response experience. Using the prompt template 258, in some implementations, the system can reduce the frequency of situations when a user needs to ask a question again or needs to clarify a question.

For example, a prompt template for the “data interpretation 222” user intent can include one or more of following system prompts:

## Role:
You are an AI assistant with expertise in data analysis.
## Objective:

| | |
|---|---|
| - | To conduct a detailed analysis of ecommerce data provided. |
| - | To offer professional opinions and recommendations based |
| | on the analysis. |

## Skills:

| | |
|---|---|
| - | Proficiency in data analysis and interpretation. |
| - | Ability to identify key trends, patterns, and anomalies in data. |

## Workflow:

| | |
|---|---|
| 1. | Review the provided data. |
| 2. | Summarize the overall performance. |
| 3. | Identify key trends and patterns. |

## Constraints:

| | |
|---|---|
| - | The analysis must be comprehensive and professional. |

As another example, a prompt template for the “data query 220” user intent or the “diagnosis/recommendation 224” user intent can include one or more of following system prompts:
sys_prompt=“-Using valid “SQLite*” and understanding basic/extra information, answer the following questions for the tables provided above. Write sql between ‘‘‘sql and ‘‘‘.\n”

In some implementations, the system can generate a prompt as an input to the generative language model 234, and the prompt can be:
prompt=schema_prompt+sys_prompt+extra_info+question_prompt
   Here, extra_info can include keywords (e.g., extra_info=f “““--keyword: {keyword} \n”””), question prompt can include a question extracted from the user message 208 (e.g., question prompt=f “--question: {question}\n”), and schema_prompt can include a path to the database that stores data (e.g., schema_prompt=self.generate_schema_prompt (db_path)+“\n”).

The system 200 (e.g., the prompt generation engine 206) selects a prompt template from a plurality of prompt templates 258 corresponding to respective intents based on the predicted intent of the user request. The system 200 (e.g., the prompt generation engine 206) generates a prompt (e.g., 228, 230, or 232) using the prompt template and the user request. The prompt can be in a standardized format by using the prompt template. The standardized prompt can help the generative language model 234 to generate a more accurate output in response to the user request.

For example, the predicted user intent can be “data query 220.” The prompt generation engine 206 can select a prompt template from a plurality of prompt templates 258 corresponding to the predicted “data query 220” user intent. The prompt generation engine 206 can generate a prompt 228 for the user request in the user message 208 using the prompt template 258 for the “data query 220” user intent and the user request. Similarly, the system 200 can generate a prompt 230 using the prompt template 258 for the “data interpretation 222” user intent. The system 200 can generate a prompt 232 using the prompt template 258 for the “diagnosis and recommendation 224” user intent.

In some implementations, the system 200 (e.g., the prompt generation engine 206) can generate the prompt (e.g., 228, 230, or 232) using the prompt template, the user request, and one or more tools 238. The tools 238 can provide context information or knowledge information that can be summarized or included in the prompt. Thus, the generative language model 234 can generate an accurate and effective out 235 using the context information or knowledge information provided by the tools.

For example, the predicted user intent can be “data query 220,” e.g., performing a query of a database using Structured Query Language (SQL). The system 200 can generate the prompt using SQL query tool 244. The SQL query tool 244 includes information related to the SQL language, e.g., syntaxes and meanings of various SQL commands. Thus, the prompt 228 can include knowledge data for SQL language, and the output 235 can include correct SQL commands.

In some implementations, the tools 238 can include suggestion recall 240, character recall 242, recall for another data structure, and more 246. In some implementations, a recall tool (such as suggestion recall 240 or character recall 242) can use Retrieval Augmented Generation (RAG) technology to select relevant data from a large amount of candidate data. For example, when performing data query (e.g., through text2sql) from tens of millions of data fields, the system can first recall relevant data fields, e.g., using minihash techniques. The system can then construct an executable SQL query using the relevant data fields.

The system 200 processes the prompt using a generative language model to generate an output. For example, the generative language model 234 can process a prompt 228 to generate the output 235. The system 200 displays, on the user interface, a response to the user request generated based on the output.

In some implementations, the generative language model 234 can be trained (e.g., trained from scratch or finetuned) on data in a specific domain to capture the characteristics of the specific domain. For example, the generative language model 234 for a conversation agent for analyzing and interpreting ecommerce data can be trained on ecommerce data and related conversations to capture the characteristics of the ecommerce domain.

In some implementations, the system 200 can process the prompt using the generative language model to generate a sequence of characters representing two or more data formats. In some implementations, the two or more data formats can include a text data format and a table data format. In some implementations, the two or more data formats can include text, numbers, symbols, or other types of characters. Other combinations of data formats are possible, such as text data and graph data, or text data and image data.

In some implementations, the system 200 can stream, on the user interface, the sequence of the characters representing the two or more data formats. In some implementations, the system can display, sequentially on the user interface, a current portion of the sequence of the characters that has been generated by the generative language model while the generative language model generates a next portion of the sequence of the characters that is after the current portion of the characters. Thus, the system 200 can reduce the response time to a user query and can improve user experience, e.g., by reducing the waiting time experienced by the user and the user can read the displayed portion of the sequence while waiting for the next portion of the sequence.

For example, the output 235 can be a sequence of characters representing text data and table data. For example, the text data can be data in a table. The output formatting engine 236 can perform formatting on the output 235 to generate an output stream 248. The system can stream, on the user interface, the output stream 248, resulting in a typewriter effect 116.

In some implementations, the system 200 can display, sequentially on the user interface (to a user 202), a first portion of the sequence of the characters representing a structure of a table and a heading of the table that has been generated by the generative language model while the generative language model generates a second portion of the sequence of the characters representing text data for the table. The system 200 can fill the table, sequentially on the user interface, using the second portion of the sequence of the characters representing the text data for the table. For example, the system can show the table first and then the system can fill the table with text in a streaming manner, as if someone is filling in the table.

In some implementations, the system 200 can display the sequence of the characters at a predetermined speed. For example, the system can display the sequence of the characters at a speed of 5 or another number of characters per second. In some implementations, the predetermined speed can be determined based on the speed that the generative language model generates the sequence of characters. For example, the system can receive 10 or another number of characters per second from the generative language model. The system can update the characters displayed in the user interface in real time, thus resulting in an animation effect.

FIGS. 3A-3D are illustrations of an example result for streaming mixed data formats at four different time points. The user request is to obtain student information. The system 200 can generate an output stream including a sequence of characters representing text data and a table that summarizes the student information.

In FIG. 3A, the system first obtains text data (sequentially) “Hello: Here is the student information:” and displays these characters sequentially on the user interface. Thus, rather than displaying the output 235 after all characters in FIG. 3D are generated, the system can provide a response to a user as soon as “H” of the “Hello” is generated by the generative language model 234. The system next obtains “|Student Name|Birthday|Height (cm)|Weight (kg)|GPA|” and displays it to build the heading and the structure of the table.

In some implementations, the system can use markdown language for creating formatted text. In FIG. 3B, the “|Student Name|Birthday|Height (cm)|Weight (kg)|GPA|” in FIG. 3A are automatically converted to the table format according to the markdown language. In some implementations, the system can generate the table from the formatted text after all the formatted text for the table (e.g., both “|Student Name|Birthday|Height (cm)|Weight (kg)|GPA|” and “|- - - |- - - |- - - ”) has been displayed on the user interface. The content of the table is shown as “Empty.”

The system continues to receive output stream 248 that includes data to fill in the table. In FIG. 3C, the system receives sequentially student information for the student named “Zhang San” and followed by the student named “Li Si.” The system sequentially displays name, birthday, height, weight, and GPA of Zhang San on the user interface. In FIG. 3D, the system has finished the output streaming and the entire output is now displayed.

Referring back to FIG. 2, in some implementations, the system 200 can receive feedback (e.g., chat message) 204 from the user 202 through the user interface. For example, the user 202 can provide feedback indicating whether the output stream 248 for a data query user request is helpful or not helpful. The system 200 can perform dialog management 212, such as associating and storing the user request (e.g., user message 208) and output stream 248 with a corresponding user feedback 204, and performing analysis on the feedback over user requests over a period of time. In some implementations, the system 200 can generate a collection of samples 214 and the samples 214 can be saved as a (historic) dialog dataset 216.

In some implementations, the system 200 can perform model training 254 using training dataset 252, for example, including the historic dialog dataset 216. For example, the system 200 can retrain or finetune the generative language model 234 using the training dataset 252. After the training is completed, the system 200 can perform model deployment 256 of the trained model to update the generative language model 234 that is being used in the conversation agent.

FIG. 4 is an illustration of an example process 400 for a conversation agent. The example process 400 shows data flowing between a user device 402, a client 404, a server 406, a generative language model (e.g., a LLM 408), and a database 410. The example process 400 can be performed by a conversation agent system, e.g., the system 100 or the system 200. The example process 400 shows the data flowing in the conversation agent system under various user cases or scenarios, including navigation 412, data query 414, data interpretation 416, diagnosis recommendation 418, FAQ recommendation 420, and feedback collection 422. Some of the scenarios can correspond to a user intent of a user request received by the system.

In some implementations, the system (e.g., the client 404 or the server 406) can determine a predicted intent of a user request received by the system. The predicted intent can include navigation 412. The system can generate a response to the user request that can help a user to navigate and locate information. In some implementations, the system can provide guidance to navigate among various modules in the system. In some implementations, the system can be divided into several modules. In some implementations, the system can maintain data for structures of the modules and data for interaction logics between the modules. In some implementations, the system can guide a user or an AI agent to switch between different modules, to make calls among different modules, and to cooperate among the different modules. Thus, in some implementations, the system can improve clarity of the system's functional organization and can improve the system's operation efficiency. In some implementations, the system can improve user experience and can improve maintainability, such as modifying, repairing, and updating the system.

For example, under the navigation scenario 412, the user device 402 provides a user request “shop data overview.” For example, a user may want to navigate to a webpage for a merchant. The client 404 can generate HumanMessage from the user request and can send the HumanMessage to the server 406. HumanMessage is a data structure that can be used to represent a message or an instruction received from an user input. In some implementations, a dialogue system can use HumanMessage data structure to differentiate information from different roles in the system. In some implementations, HumanMessage can identify user input, such that a language model can process and respond to the user input. The server 406 can generate an intent analysis result indicating a predicted user intent for the user request. The LLM 408 can generate a relevance matching based on the predicted user intent. For example, the LLM 408 can identify the webpage for the merchant. The LLM 408 can provide the relevance matching result to the server 406. The server 406 can perform link embedding, e.g., adding a link to the webpage in the output steam that identifies the shop. The client 404 can generate an output stream “shop performance: reason,” and “shop performance” includes the embedded link. The user device 402 can display the output stream.

In some implementations, the predicted intent can include data query 414. The system can process a prompt generated based on the predicted intent using a generative language model (e.g., the LLM 408) to generate an output. The output can be in a domain-specific language used to manage data. The system (e.g., the server 406) can perform the data query using the output in the domain-specific language.

In some implementations, the domain-specific language can be SQL, and the prompt can include text data in natural language. The generative language model can be a model trained to generate SQL queries from natural language text data. The system can process the prompt including the text data in the natural language using the generative language model (e.g., the LLM 408) to generate the output including a SQL query. The system (e.g., the server 406) can retrieve data from a database using the SQL query. The system (e.g., the client 404) can display, on the user interface, the retrieved data.

For example, under the data query scenario 414, the user device 402 provides a user request “shop xxx's GMV this week vs. last.” The client 404 can generate HumanMessage from the user request. The server 406 can generate a prompt for information extraction. For example, the prompt can ask the LLM 408 to generate one or more SQL queries to retrieve data from a SQL database. The LLM 408 can generate a complete SQL query as instructed in the prompt. The server 406 can perform data query by sending the SQL query to the database 410. The database 410 can return a query result.

In some implementations, the data stored in the database 410 can be organized into categories (e.g., scenarios or use cases). For example, the data can have a label indicating whether the data is related to a livestreaming scenario, a video sharing scenario, or an ecommerce scenario. Thus, the system can query data stored in the database effectively using the categories.

In some implementations, before sending the SQL query to the database 410, the server 406 can perform permission filtering. The server 406 can determine whether the user has permission to query the data at the database 410. If the server 406 determines that the user does not have permission to query the data at the database 410, the server 406 can send a response to the user, e.g., “Sorry, you don't have data access.” If the server 406 determines that the user has permission to query the data at the database 410, the server 406 can query the data in the database 410 as discussed herein.

After obtaining the data from the database 410, the server 406 can perform output formatting based on the data formats to generate formatted data. For example, the formatted data can include mixed data formats, such as the examples described in connection with FIGS. 3A-3D. The client 404 can display, on a display of the user device 402, the formatted data.

In some implementations, the predicted intent of a user request can include data interpretation 416. The system can process the prompt using the generative language model (e.g., the LLM 408) to generate a data interpretation result. The system can display, on the user interface, the data interpretation result.

For example, under the data interpretation scenario 416, the user device 402 provides a user request “help me analyze the above data.” The client 404 can generate HumanMessage from the user request and can send the HumanMessage to the server 406. The server 406 can generate a prompt (e.g., based on the predicted intent of data interpretation) asking the LLM 408 to perform data interpretation. The LLM 408 can generate a relevance matching based on the predicted user intent. For example, the LLM 408 can generate an interpretation result and can provide the interpretation result to the server 406. The server 406 can perform a compliance check to determine whether the interpretation result complies to predetermined rules. In some implementations, the predetermined rules used in the compliance check can be determined based on domestic laws and regulations, international laws and regulations, industry norms, ethical standards, and other requirements. Through compliance check, in some implementations, the system can systematically review the content of the dialog (e.g., the interpretation result) to ensure compliance with the predetermined rules, and to prevent and control possible legal risks, ethical risks, and security risks.

If the interpretation result passes the compliance check, the server 406 can send the interpretation result to the client 404. The client 404 can generate an output stream using the interpretation result, such as “From the data we can see.” The user device 402 can display the output stream.

In some implementations, the predicted intent of a user request can include seeking a recommendation (e.g., diagnosis and recommendation 418). The system can process the prompt using the generative language model (e.g., the LLM 408) to generate recommendation data. The system can display, on the user interface, the recommendation data.

For example, under the diagnosis and recommendation 418, the user device 402 provides a user request “Any suggestions for this shop?” The client 404 can generate HumanMessage from the user request and can send the HumanMessage to the server 406. The server 406 can generate a prompt (e.g., based on the predicted intent of diagnosis and recommendation) asking the LLM 408 to provide an in-depth advice based on the data interpretation result. The LLM 408 can generate a relevance matching based on the predicted user intent. For example, the LLM 408 can generate High-Value Action (HVA) recommendations. HVA in ecommerce are user actions that lead to downstream conversions or generate significant value for the business. The LLM 408 can provide the HVA recommendations to the server 406. The server 406 can send the HVA recommendations to the client 404. The client 404 can generate an output stream using the HVA recommendations, such as “1, . . . with Gross Merchandise Value (GMV) uplift expectation 8%.” The user device 402 can display the output stream.

In some implementations, the conversation agent system can recommend a question that a user might want to ask. In some implementations, the system can be in the FAQ recommendation scenario 420. The system can process a prompt using the generative language model to generate a question that a user might want to ask. The system can display, on the user interface, the recommended question to ask.

For example, under the FAQ recommendation scenario 420, the LLM 408 can access data and applications from the database 410. The data and applications can include historical user requests in various applications, e.g., user cases and scenarios. Based on the current conversation data (e.g., the result of one or more of: data query 414, data interpretation 416, diagnosis and recommendation 418), the system can process a prompt using the generative language model (e.g., the LLM 408) to generate a model recommendation result. The model recommendation result, for example, can indicate a topic that the user might want to ask. The LLM 408 can send the model recommendation result to the server 406. The server 406 can identify an appropriate question and a corresponding answer (e.g., a FAQ card) based on the model recommendation result. The server 406 can send the FAQ card to the client 404. The client 404 can generate an output stream using the FAQ card, such as “What you might want to ask:” The user device 402 can display the output stream.

In some implementations, the conversation agent system can collect feedback from a user. The system can use the collected feedback to improve the generative language model.

For example, under the feedback collection 422 scenario, a user can interact with the user device 402 to provide feedback data, e.g., clicking on “helpful” or “unhelpful” displayed on the user interface of the conversation agent system. The client 404 can receive the feedback data from the user device 402. The client 404 can provide the feedback data to the server 406. The server 406 can perform data collection and can store the feedback data in the database 410. The system can perform model improvement. The system can train, retrain, or fine-tune the LLM 408 or a new LLM model using the collected feedback data, e.g., over a period of time and from one or more users.

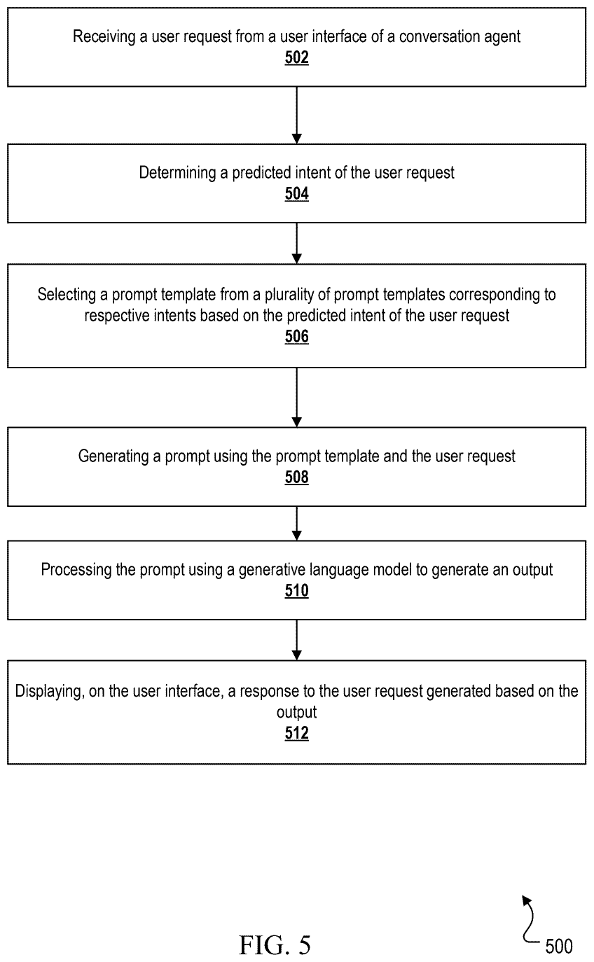

FIG. 5 is a flow diagram that illustrates an example process 500 for a conversation agent. The process 500 can be implemented, for example, by a system executing one or more programs of the application. In some implementations, the system can include an electronic device and one or more servers. The system, the electronic device, and/or the servers each can include one or more processors, and one or more computer-readable memories coupled to the one or more processors and having instructions stored thereon, wherein the instructions are executable by the one or more processors to perform some or all operations of the process 500, and/or additional or different operations. The process 500 will be described with reference to elements as illustrated in FIGS. 1A-C, FIG. 2, and FIG. 4. It should be noted that while the elements in FIGS. 1A-C, FIG. 2, and FIG. 4 are described herein as examples, these are not meant to be limiting, and the process 500 can be performed with respect to any suitable elements. The operations shown in process 500 may not be exhaustive and other operations can be performed as well before, after, or in between any of the illustrated operations. Further, some of the operations may be omitted, performed simultaneously, or in a different order than shown in FIG. 5.

The system receives a user request from a user interface of a conversation agent (502). The system determines a predicted intent of the user request (504). Examples for predicted intent of a user request is described above with reference to FIGS. 1A-C, FIG. 2 and FIG. 4.

The system selects a prompt template from a plurality of prompt templates corresponding to respective intents based on the predicted intent of the user request (506). The system generates a prompt using the prompt template and the user request (508). An example for selecting a prompt template and generating a prompt using the selected prompt template is described above with reference to FIG. 2.

The system processes the prompt using a generative language model (e.g., LLM 103, NLP model 165, LLM 408) to generate an output (510). In some implementations, the predicted intent can include data query, the output can be in a domain-specific language used to manage data. The system can perform the data query using the output in the domain-specific language. Examples are described above with reference to FIGS. 1A-C, FIG. 2 and FIG. 4.

In some implementations, the domain-specific language can be Structured Query Language (SQL), the prompt can include text data in natural language. The system can process the prompt including the text data in the natural language using the generative language model to generate the output including a SQL query. The generative language model can be trained to generate SQL queries from natural language text data. The system can retrieve data from a database using the SQL query. The system can display, on the user interface, the retrieved data. Examples are described above with reference to FIGS. 1A-C, FIG. 2 and FIG. 4.

In some implementations, the predicted intent can include data interpretation. The system can process the prompt using the generative language model to generate a data interpretation result. In some implementations, the system can display, on the user interface, the data interpretation result. Examples are described above with reference to FIGS. 1A-C, FIG. 2 and FIG. 4.

In some implementations, the predicted intent can include seeking a recommendation. The system can process the prompt using the generative language model to generate recommendation data. The system can display, on the user interface, the recommendation data. Examples are described above with reference to FIGS. 1A-C, FIG. 2 and FIG. 4.

The system displays, on the user interface, a response to the user request generated based on the output (512). In some implementations, the system can process the prompt using the generative language model to generate a sequence of characters representing two or more data formats. In some implementations, the two or more data formats can include: a text data format and a table data format. In some implementations, the system can stream, on the user interface, the sequence of the characters representing the two or more data formats. In some implementations, the system can display, sequentially on the user interface, a current portion of the sequence of the characters that has been generated by the generative language model while the generative language model generates a next portion of the sequence of the characters that is after the current portion of the characters. Examples are described above with reference to FIGS. 1A-C, FIG. 2 and FIGS. 3A-3D.

In some implementations, the system can display, sequentially on the user interface, a first portion of the sequence of the characters representing a structure of a table and a heading of the table that has been generated by the generative language model while the generative language model generates a second portion of the sequence of the characters representing text data for the table. The system can fill the table, sequentially on the user interface, using the second portion of the sequence of the characters representing the text data for the table. Examples are described above with reference to FIGS. 1A-C, FIG. 2 and FIGS. 3A-3D.

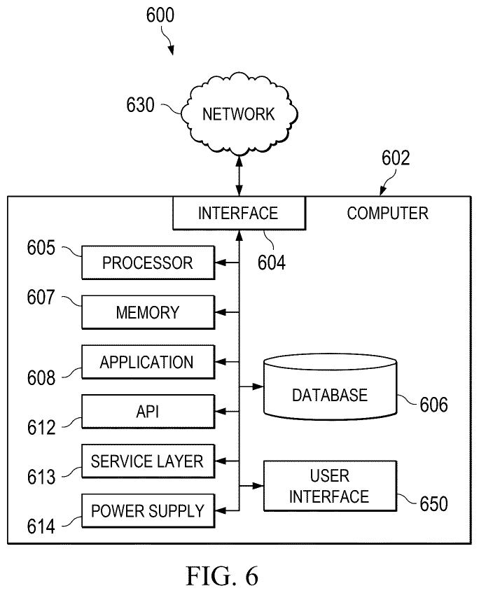

FIG. 6 illustrates a block diagram of an example computer system 600 used to provide computational functionalities associated with described algorithms, methods, functions, processes, flows, and procedures, as described in the disclosure, according to one or more implementations. The example computer system 600 can include an electronic device 602 and a network 630. The computer system 600 can include additional or different components, such as, one or more remote servers that are communicatively linked with the electronic device 602.

The electronic device 602 can include a digital TV, a desktop computer, a work station, a smart appliance, or another stationary terminal. In some implementations, the electronic device 602 is a portable device, such as, a notebook computer, a digital broadcast receiver, a handheld device, a portable multimedia player (PMP), an in-vehicle terminal, an Internet of Things (IoT) device. For example, the electronic device 602 can be a phone, a smartphone, a pad (tablet computer), a digital assistant device (e.g., a PDA (personal digital assistant)), or another handheld device.

In some aspects, the electronic device 602 may include a computer that includes a user interface 650. The user interface 650 can include an input device, such as a keypad, keyboard, touch screen/touch display, camera, microphone, accelerometer, gyroscope, AR/VR sensors, or other device that can accept user information, and an output device that conveys information associated with the operation of the electronic device 602, including digital data, visual, or audio information (or a combination of information), or a graphical user interface (GUI). In some implementations, the user interacts with the GUI, for example, through contacts and/or gestures on or in front of the touch screen, for example, to implement the functions such as digital photographing/videoing, instant messaging, social network interacting, image/video editing, drawing, presenting, word/text processing, website creating, game playing, telephoning, video conferencing, e-mailing, web browsing, digital music/digital video playing, etc.

The electronic device 602 can serve in a role as a client, network component, a server, a database or other data store, or any other component (or a combination of roles) of a computer system for performing the subject matter described in the instant disclosure. The illustrated electronic device 602 is communicably coupled with a network 630. In some implementations, one or more components of the electronic device 602 may be configured to operate within environments, including cloud-computing-based, local, global, or other environments (or a combination of environments).

At a high level, the electronic device 602 is an electronic computing device operable to receive, transmit, process, store, or manage data and information associated with the described subject matter. According to some implementations, the electronic device 602 may also include, or be communicably coupled with, an application server, e-mail server, web server, caching server, streaming data server, or other server (or a combination of servers).

The electronic device 602 can receive requests over network 630 from a client application (for example, executing on another electronic device 602) and respond to the received requests by processing the received requests using an appropriate software application(s). In addition, requests may also be sent to the electronic device 602 from internal users (for example, from a command console or by other appropriate access methods), external or third-parties, other automated applications, as well as any other appropriate entities, individuals, systems, or computers.

Each of the components of the electronic device 602 can communicate using a system bus 603. In some implementations, any or all of the components of the electronic device 602, hardware or software (or a combination of both hardware and software), may interface with each other or the interface 604 (or a combination of both), over the system bus 603 using an application programming interface (API) 612 or a service layer 613 (or a combination of the API 612 and service layer 613). The API 612 may include specifications for routines, data structures, and object classes. The API 612 may be either computer-language independent or dependent and refer to a complete interface, a single function, or even a set of APIs. The service layer 613 provides software services to the electronic device 602 or other components (whether or not illustrated) that are communicably coupled to the electronic device 602. The functionality of the electronic device 602 may be accessible for all service consumers using this service layer. Software services, such as those provided by the service layer 613, provide reusable, defined functionalities through a defined interface. For example, the interface may be software written in JAVA, C++, or other suitable language providing data in extensible markup language (XML) format or other suitable formats. While illustrated as an integrated component of the electronic device 602, alternative implementations may illustrate the API 612 or the service layer 613 as stand-alone components in relation to other components of the electronic device 602 or other components (whether or not illustrated) that are communicably coupled to the electronic device 602. Moreover, any or all parts of the API 612 or the service layer 613 may be implemented as child or sub-modules of another software module, enterprise application, or hardware module without departing from the scope of this disclosure.

The electronic device 602 includes an interface 604. Although illustrated as a single interface 604 in FIG. 6, two or more interfaces 604 may be used according to particular needs, desires, or particular implementations of the electronic device 602. The interface 604 is used by the electronic device 602 for communicating with other systems that are connected to the network 630 (whether illustrated or not) in a distributed environment. Generally, the interface 604 includes logic encoded in software or hardware (or a combination of software and hardware) and is operable to communicate with the network 630. More specifically, the interface 604 may include software supporting one or more communication protocols associated with communications such that the network 630 or interface's hardware is operable to communicate physical signals within and outside of the illustrated electronic device 602.

The electronic device 602 includes a processor 605. Although illustrated as a single processor 605 in FIG. 6, two or more processors may be used according to particular needs, desires, or particular implementations of the electronic device 602. Generally, the processor 605 executes instructions and manipulates data to perform the operations of the electronic device 602 and any algorithms, methods, functions, processes, flows, and procedures as described in the instant disclosure.

The electronic device 602 also includes a database 606 that can hold data for the electronic device 602 or other components (or a combination of both) that can be connected to the network 630 (whether illustrated or not). For example, database 606 can be an in-memory, conventional, or other type of database storing data consistent with this disclosure. In some implementations, database 606 can be a combination of two or more different database types (for example, a hybrid in-memory and conventional database) according to particular needs, desires, or particular implementations of the electronic device 602 and the described functionality. Although illustrated as a single database 606 in FIG. 6, two or more databases (of the same or combination of types) can be used according to particular needs, desires, or particular implementations of the electronic device 602 and the described functionality. While database 606 is illustrated as an integral component of the electronic device 602, in alternative implementations, database 606 can be external to the electronic device 602.

The electronic device 602 also includes a memory 607 that can hold data for the electronic device 602 or other components (or a combination of both) that can be connected to the network 630 (whether illustrated or not). For example, memory 607 can include a non-transitory computer readable storage medium or other computer program product that store executable instructions configured for execution by one or more processors 605 for performing the functionality described in this disclosure. Memory 607 can be Random Access Memory (RAM), Read Only Memory (ROM), optical, magnetic, and the like, storing data consistent with this disclosure. In some implementations, memory 607 can be a combination of two or more different types of memory (for example, a combination of RAM and magnetic storage) according to particular needs, desires, or particular implementations of the electronic device 602 and the described functionality. Although illustrated as a single memory 607 in FIG. 6, two or more memories 607 (of the same or a combination of types) can be used according to particular needs, desires, or particular implementations of the electronic device 602 and the described functionality. While memory 607 is illustrated as an integral component of the electronic device 602, in alternative implementations, memory 607 can be external to the electronic device 602.

The application 608 is an algorithmic software engine providing functionality according to particular needs, desires, or particular implementations of the electronic device 602, particularly with respect to functionality described in this disclosure. The application 608 can be associated with a platform that includes one or more application servers. For example, application 608 can include one or more of a social network application, video sharing application, text/image/video/audio editing/presentation application, etc. Application 608 can serve as one or more components, modules, or applications. Further, although illustrated as a single application 608, the application 608 may be implemented as multiple applications 608 on the electronic device 602. In addition, although illustrated as integral to the electronic device 602, in alternative implementations, at least part of the application 608 can be external to the electronic device 602. For example, one or more programs of the application 608 can execute on an application server remote to the electronic device 602.

The electronic device 602 can also include a power supply 614. The power supply 614 can include a rechargeable or non-rechargeable battery that can be configured to be either user- or non-user-replaceable. In some implementations, the power supply 614 can include power-conversion or management circuits (including recharging, standby, or other power management functionality). In some implementations, the power supply 614 can include a power plug to allow the electronic device 602 to be plugged into a wall socket or other power source to, for example, power the electronic device 602 or recharge a rechargeable battery.

There may be any number of computers 602 associated with, or external to, a computer system containing electronic device 602, each electronic device 602 communicating over network 630. Further, the term “client,” “user,” and other appropriate terminology may be used interchangeably, as appropriate, without departing from the scope of this disclosure. Moreover, this disclosure contemplates that many users may use one electronic device 602, or that one user may use multiple computers 602.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for displaying characters in an output stream following the generation of the characters in the output stream by a generative language model can be less than 1 millisecond (ms), less than 1 second(s), or less than 5 s.

ISI, the term “engine,” “planner,” “executor,” “evaluator” “manager,” “reflector,” “interface,” “generator,” “service,” “tool,” “client,” or “server” is used broadly to refer to a software-based system or subsystem that can perform one or more specific functions, for example, based on the algorithms or methods described in this specification and/or other algorithms or methods a person of ordinary skill in the art would have known and understood. Generally, an engine (or a planner, an executor, an evaluator, a manager, a reflector, an interface, a generator, a service, a tool, a client, a server) will be implemented as one or more software modules or components, installed on one or more computers in one or more locations. In some cases, one or more computers will be dedicated to a particular engine (or planner, executor, evaluator, manager, reflector, interface, generator, service, tool, client, server); in other cases, multiple engines (or planners, executors, evaluators, managers, reflectors, interfaces, generators, services, tools, clients, servers) can be installed and running on the same computer or computers. In some implementations, an engine (or a planner, an executor, an evaluator, a manager, a reflector, an interface, a generator, a service, a tool, a client, a server) can be implemented as one or more software, firmware, hardwire modules or components, or a combination thereof.

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A computer-implemented method, comprising:
receiving a user request from a user interface of a conversation agent;
determining a predicted intent of the user request;
selecting a prompt template from a plurality of prompt templates corresponding to respective intents based on the predicted intent of the user request;
generating a prompt using the prompt template and the user request;
processing the prompt using a generative language model to generate an output; and
displaying, on the user interface, a response to the user request generated based on the output.

2. The method of claim 1, wherein the predicted intent comprises data query, the output is in a domain-specific language used to manage data, and the method comprises:
performing the data query using the output in the domain-specific language.

3. The method of claim 2, wherein the domain-specific language is Structured Query Language (SQL), the prompt comprises text data in natural language, and the method comprises:
processing the prompt comprising the text data in the natural language using the generative language model to generate the output comprising a SQL query, wherein the generative language model is trained to generate SQL queries from natural language text data;
retrieving data from a database using the SQL query; and
displaying, on the user interface, the retrieved data.

4. The method of claim 1, wherein the predicted intent comprises data interpretation, and the method comprises:
processing the prompt using the generative language model to generate a data interpretation result; and
displaying, on the user interface, the data interpretation result.

5. The method of claim 1, wherein the predicted intent comprises seeking a recommendation, and the method comprises:
processing the prompt using the generative language model to generate recommendation data; and
displaying, on the user interface, the recommendation data.

6. The method of claim 1, comprising:
processing the prompt using the generative language model to generate a sequence of characters representing two or more data formats; and
streaming, on the user interface, the sequence of the characters representing the two or more data formats, wherein the streaming comprises:
displaying, sequentially on the user interface, a current portion of the sequence of the characters that has been generated by the generative language model while the generative language model generates a next portion of the sequence of the characters that is after the current portion of the characters.

7. The method of claim 6, wherein the two or more data formats comprise: a text data format and a table data format.

8. The method of claim 7, wherein the streaming the sequence of the characters comprises:
displaying, sequentially on the user interface, a first portion of the sequence of the characters representing a structure of a table and a heading of the table that has been generated by the generative language model while the generative language model generates a second portion of the sequence of the characters representing text data for the table; and
filling the table, sequentially on the user interface, using the second portion of the sequence of the characters representing the text data for the table.

9. An apparatus, comprising:
one or more processors; and
one or more computer-readable memories coupled to the one or more processors and having instructions stored thereon, wherein the instructions are executable by the one or more processors to perform operations comprising:
receiving a user request from a user interface of a conversation agent;
determining a predicted intent of the user request;
selecting a prompt template from a plurality of prompt templates corresponding to respective intents based on the predicted intent of the user request;
generating a prompt using the prompt template and the user request;
processing the prompt using a generative language model to generate an output; and
displaying, on the user interface, a response to the user request generated based on the output.

10. The apparatus of claim 9, wherein the predicted intent comprises data query, the output is in a domain-specific language used to manage data, and the operations comprise:
performing the data query using the output in the domain-specific language.

11. The apparatus of claim 10, wherein the domain-specific language is Structured Query Language (SQL), the prompt comprises text data in natural language, and the operations comprise:
processing the prompt comprising the text data in the natural language using the generative language model to generate the output comprising a SQL query, wherein the generative language model is trained to generate SQL queries from natural language text data;
retrieving data from a database using the SQL query; and
displaying, on the user interface, the retrieved data.

12. The apparatus of claim 9, wherein the predicted intent comprises data interpretation, and the operations comprise:
processing the prompt using the generative language model to generate a data interpretation result; and
displaying, on the user interface, the data interpretation result.

13. The apparatus of claim 9, wherein the predicted intent comprises seeking a recommendation, the operations comprise:
processing the prompt using the generative language model to generate recommendation data; and
displaying, on the user interface, the recommendation data.

14. The apparatus of claim 9, wherein the operations comprise:
processing the prompt using the generative language model to generate a sequence of characters representing two or more data formats; and
streaming, on the user interface, the sequence of the characters representing the two or more data formats, wherein the streaming comprises:
displaying, sequentially on the user interface, a current portion of the sequence of the characters that has been generated by the generative language model while the generative language model generates a next portion of the sequence of the characters that is after the current portion of the characters.

15. The apparatus of claim 14, wherein the two or more data formats comprise: a text data format and a table data format.

16. The apparatus of claim 15, wherein the streaming the sequence of the characters comprises:
displaying, sequentially on the user interface, a first portion of the sequence of the characters representing a structure of a table and a heading of the table that has been generated by the generative language model while the generative language model generates a second portion of the sequence of the characters representing text data for the table; and
filling the table, sequentially on the user interface, using the second portion of the sequence of the characters representing the text data for the table.

17. A non-transitory computer readable storage medium, wherein the non-transitory computer readable storage medium stores programing instructions executable by one or more processors to perform operations comprising:
receiving a user request from a user interface of a conversation agent;
determining a predicted intent of the user request;
selecting a prompt template from a plurality of prompt templates corresponding to respective intents based on the predicted intent of the user request;
generating a prompt using the prompt template and the user request;
processing the prompt using a generative language model to generate an output; and
displaying, on the user interface, a response to the user request generated based on the output.

18. The non-transitory computer readable storage medium of claim 17, wherein the predicted intent comprises data query, the output is in a domain-specific language used to manage data, and the operations comprise:
performing the data query using the output in the domain-specific language.

19. The non-transitory computer readable storage medium of claim 18, wherein the domain-specific language is Structured Query Language (SQL), the prompt comprises text data in natural language, and the operations comprise:
processing the prompt comprising the text data in the natural language using the generative language model to generate the output comprising a SQL query, wherein the generative language model is trained to generate SQL queries from natural language text data;
retrieving data from a database using the SQL query; and
displaying, on the user interface, the retrieved data.

20. The non-transitory computer readable storage medium of claim 17, wherein the predicted intent comprises data interpretation, and the operations comprise:
processing the prompt using the generative language model to generate a data interpretation result; and
displaying, on the user interface, the data interpretation result.
